(19) United States
(12) Patent Application Publication
(10) Pub. No.: US 2013/0037438 A1
(43) Pub. Date: Feb. 14, 2013

(54) CONTAINER FOR PRODUCTS, IN PARTICULAR SMOKING PRODUCTS, AND METHOD FOR MAKING THE CONTAINER

(71) Applicants: Imerio Dall'Olio, Zola Predosa (Bologna) (IT); Eugenio Navacchia, Bologna (IT); Claudio Adriano Zanardi, Argelato (Bologna) (IT); Roberto Polloni, Modigliana (Forli-Cesena) (IT); Andrea Biodi, Bologna (IT)

(72) Inventors: Imerio Dall'Olio, Zola Predosa (Bologna) (IT); Eugenio Navacchia, Bologna (IT); Claudio Adriano Zanardi, Argelato (Bologna) (IT); Roberto Polloni, Modigliana (Forli-Cesena) (IT); Andrea Biodi, Bologna (IT)

(73) Assignee: G.D S.P.A., Bologna (IT)

(21) Appl. No.: 13/641,614

(22) PCT Filed: Apr. 14, 2011
(86) PCT No.: PCT/IB2011/051624

§ 371 Date: Oct. 16, 2012

(30) Foreign Application Priority Data
Apr. 23, 2010 (IT) BO2010A000252

(51) Int. Cl. B65D 85/00; B31B 3/00

(52) U.S. Cl. 206/524.6; 493/162

(57) ABSTRACT

A method for making hard cigarette packets comprises a plurality of folding steps performed on blanks and a plurality of fixing steps performed by sealing predetermined areas of the blanks. In those areas, the blanks are furnished with strips, comprising a layer of electrically conductive metallic material which is made to fuse at least partly by passing it through an electromagnetic field or by passing an electrostatic charge or an electric current through it.

### TECHNICAL FIELD

This invention relates to a container for products and to a method for making it

What is stated in this description with reference to cigarette containers consisting of hard, hinged-lid packets shall apply also to other types of products, in particular to soft cigarette packets and cartons of cigarette packets.

### BACKGROUND ART

As is known, machines for making hard, hinged-lid cigarette packets use blanks made of relatively rigid material (card or plastic) provided with a plurality of crease lines which divide them into panels and tabs which are designed to make up the walls of the packets.

Each blank is associated with a group of cigarettes previously wrapped in an inner wrap around which the blank is folded by fixed and movable folders.

The tabs and panels of the blank, designed to be superposed and joined to each other to form the walls of the packet, are subjected to a gumming operation.

The gumming operation may be performed by gumming devices consisting of a plurality of embossed rollers which are dipped into a tank containing an adhesive substance or by spray gummers equipped with a plurality of nozzles.

In particular, the adhesive substance used is a vinyl glue which tends to clot and dirty the machine parts it comes into contact with. Periodic cleaning and maintenance operations on the packing machine thus become necessary.

Prior art packing machines also comprise an outfeed device consisting of a channel for drying the adhesive substance.

Inside the channel, the packets flowing uninterruptedly and in contact with each other are subjected to heating and if necessary to a shape regularization operation (“calibration”) performed by vibrating plates constituting the walls of the channel.

From the above, it is clear that, leaving aside the drawbacks connected with the use of the above mentioned roller or spray devices, the gumming devices and the glue drying device constitute a very cumbersome and expensive part of the packing machine.

### DISCLOSURE OF THE INVENTION

The aim of this invention is to provide a container and a method for making the same which are free of the above mentioned disadvantages.

This invention accordingly provides a method and a container having the features set out in one or more of the appended claims.

### BRIEF DESCRIPTION OF THE DRAWINGS

The invention will now be described with reference to the accompanying drawings which illustrate a preferred embodiment of it and in which:

FIG. 1 is a schematic perspective view of a portion of a cigarette packing machine designed to make the packets according to this invention;

FIGS. 2 and 3 are perspective views showing a cigarette packet of the hinged-lid type in the closed condition and in the open condition, respectively;

FIGS. 4 and 5 are perspective views showing, respectively, the inside face and the outside face of a blank for making the packet of FIG. 2;

FIG. 6 is a perspective view of an inner frame or internal member of the packet of FIG. 2;

FIG. 7 is a scaled-up schematic representation of a detail from FIG. 1;

FIG. 8 is a schematic representation of a second embodiment of the detail from FIG. 1;

FIG. 9 shows a cross section of a detail from FIGS. 4, 5, 6;

FIG. 10 shows a second embodiment of the detail of FIG. 9; and

FIG. 11 shows a third embodiment of the detail of FIG. 9.

### DETAILED DESCRIPTION OF THE PREFERRED EMBODIMENTS OF THE INVENTION

With reference to FIGS. 2 and 3, the numeral 1 denotes a cigarette packet in the shape of a right-angled parallelepiped with a longitudinal axis A and comprising an inner wrap 2 enclosing a group 3 of cigarettes 4 oriented parallel to the axis A and an outer wrap 5 made of card and consisting of box-shaped body 6 and a hinged lid 7 movable between a position where it closes and a position where it opens the box-shaped body 6.

An internal member or inner frame 8 is fixed to the box-shaped body 6 and projects outside the box-shaped body 6 in such a way as to form an element for guiding and stiffening the lid 7 in the closed condition.

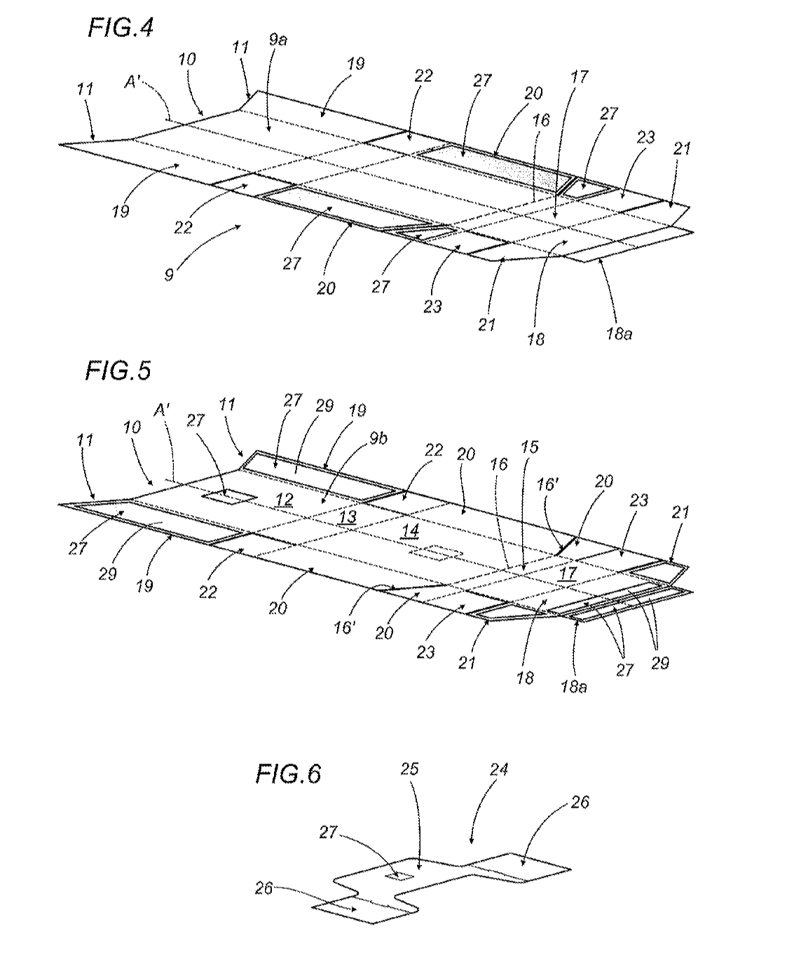

With reference to FIGS. 4 and 5, the numeral 9 denotes a card blank from which the packet 1 is made.

The blank 9, which is substantially rectangular in shape, is provided with a plurality of crease lines which divide it into a central portion 10 and two lateral portions 11, positioned symmetrically, one on each side of the central portion 10 parallel to the axis A′.

The central portion 10 comprises a first panel 12 forming a front wall of the box-shaped body 6, a second panel 13 forming an end wall of the box-shaped body 6, a third panel 14 forming a rear wall of the box-shaped body 6, a fourth panel 15, separated from the panel 14 by a hinge line 16 and forming a rear wall of the lid 7, a fifth panel 17 forming an end wall of the lid 7, and a sixth panel 18 forming a front wall of the lid 7, from which an end panel 18a projects.

Each lateral panel 11 comprises a flap 19 extending laterally from the panel 12, a flap 20 extending laterally from the panels 14 and 15 and a flap 21 extending laterally from the panel 18.

Each flap 20 is divided into two portions by oblique slits 16 which extend from the two ends of the hinge line 16.

Each flap 20 has at the opposite longitudinal ends of it two longitudinal flaps 22 and 23, the first of which is positioned on the outside of a respective lateral edge of the panel 13, and the second of which is positioned on the outside of a respective lateral edge of the panel 17.

With reference to FIG. 6, the numeral 24 denotes a blank, made of card, from which the inner frame 8 is made by a series steps of folding the blank.

The blank 24 has two parallel crease lines which divide it into a central portion 25 and two lateral portions or flaps 26.

The outside face 9a (FIG. 4) and the inside face 9b (FIG. 5) of the blank 9, and the inner frame 8 are furnished, at predetermined areas, with strips 27, comprising a layer of adhesive material 28 whereby they are applied to the card blanks 9 and 24 and an outwardly facing layer 29 made of electrically conductive metallic material (FIG. 9).

The metallic layer 29 may consist of a plain metallic film or a metallic film externally coated with a protective plastic layer or a paper material containing metallic particles or even metallic powder made adherent, for example by an adhesive substance, to the surface of the paper material.

Alternatively, with reference to FIG. 10, the strip 27 comprises a conductive or metallic layer 29 interposed between two layers 30 of thermoplastic material (for example polypropylene) or it may consist of a more complex multiple layer including at least one intermediate layer of conductive or metallic material.

More specifically, on the outside face 9a, the strips 27 are applied at the two flaps 20, whereas on the inside face 9b, the strips 27 are applied at the two flaps 19, at a central area of the wall 12, at the two flaps 21, at the wall 18 of the lid 7 and at the end panel 18a adjacent to the wall 18 itself.

In the same way, one strip 27 is applied to the outside face of the central portion 25 of the blank 24.

From what is stated above, it is evident that the strips 27 comprising the metallic layer 29 are applied in different areas of the blank 9 and of the inner frame 8 which in the prior art are joined to each other by an adhesive substance.

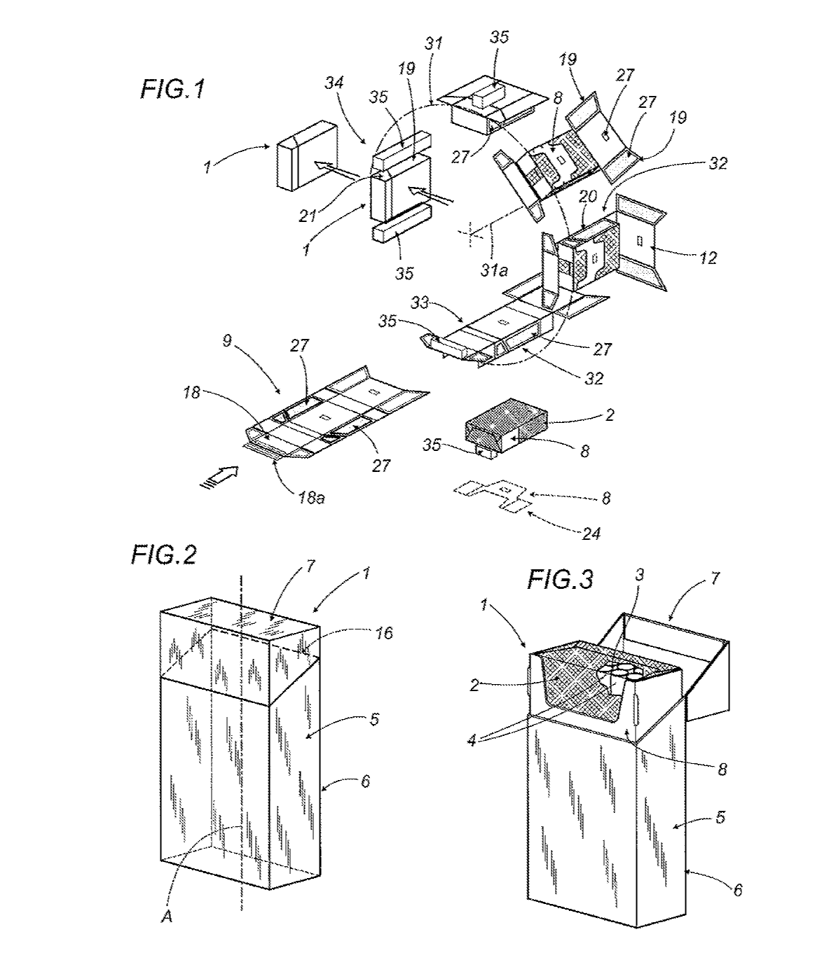

With reference to FIG. 1, which illustrates by way of a non-limiting example a portion of a packing machine, the blanks 9, to which the strips 27 have been applied previously, are fed in succession by a conveyor, not illustrated, to a wrapping wheel 31 of known type which rotates about a horizontal axis 31a and which is equipped with radial compartments 32 spaced at equal angular intervals.

After folding the tab 18a into contact with the panel 18, each blank 9 is coupled, at an infeed station 33, to a group of cigarettes 3 wrapped in the inner wrap 2, already furnished with the blank 24 of the inner frame 8.

The assembly made up of the blank 9, the blank 24 and the wrap 2 containing the group of cigarettes 3 is then inserted into a compartment 32 of the wrapping wheel 31.

After an anticlockwise rotation of the wheel substantially through 270 each assembly is transferred by the wheel 31 to an outfeed station 34.

During its transfer into the compartment 32 of the wrapping wheel 31 and its passage through the outfeed station 34 a series of folding operations are performed according to a known method, mentioned briefly here, whose end result is the packet 1.

More specifically, during the rotation of the wheel 31 the front wall 12 is pressed against the central wall 25 of the inner frame 8, and in the outfeed station 34 the flaps 19 and the flaps 21 are pressed against the flaps 20 in such a way as to form the lateral walls of the box-shaped body 6 and of the lid 7.

Downstream of all the folding devices, not illustrated, which perform the above mentioned folding operations whereby the parts of the blank 9 and of the blank 24 provided with the strips 27 are brought into mutual contact, there are provided sealing means, schematically represented as blocks 35, which stably fix the panels and flaps of the blanks 9 and 24 to each other by fusing together the metallic layer 29 or the layers of thermoplastic material 30.

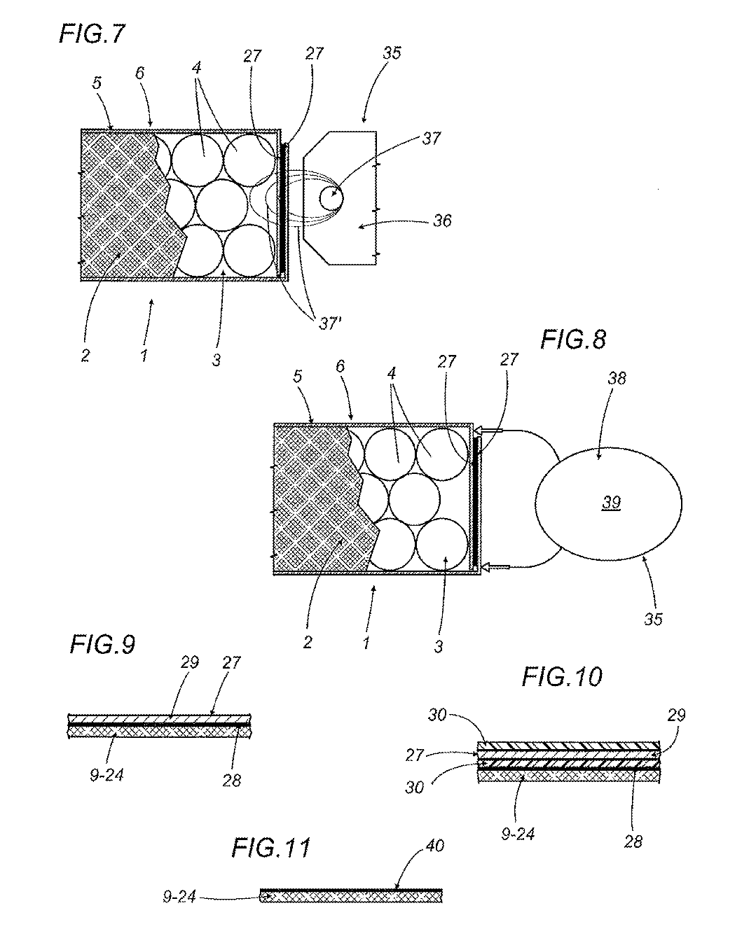

With reference to FIG. 7, each of the sealers 35 comprises a device 36, equipped with an electromagnet 37 which, when the outer wraps 5 being formed pass through the electromagnetic field 37′, cause the superposed metallic layers 29 to be heated by electromagnetic induction.

Consequently, by fusing together the metallic layers 29 themselves (FIG. 9), or by fusing together the layers 30 of thermoplastic material between which the metallic layers 29 are interposed (FIG. 10), or by fusing together at least the outside layer 30 of thermoplastic material which is superposed over the metallic layer 29 (if there is no inside thermoplastic layer 30 in contact with the adhesive 28) the panels and flaps of the packet 1 are joined to each other.

FIG. 8 illustrates a second embodiment of the sealing means 35, where the fusion heat is obtained through an electric circuit 38 comprising a voltage and/or current generator 39, which causes electrostatic charges between the superposed strips 27 or causes direct or alternating electric current to pass between the two superposed strips 27 themselves.

What has been stated with regard to hard, hinged-lid packets can obviously be extended to other types of containers such as for example, hard cigarette packets with different flap and panel arrangements, soft cigarette packets or cartons of cigarettes, and more in general, to all operations which, in packing machines of known type, involve the use of an adhesive material, such as, for example, the application of revenue stamps and the fastening of inner wrap 2 containing the group of cigarettes 3 to the outer wrap 5.

In a further embodiment, illustrated in FIG. 1 the meta c layer 29 may consist of a metallic varnish 40 such as, for example, an acrylic resin containing dispersed conductive pigments and pre-applied to the blank 9.

1. A method of making product containers, comprising a plurality of folding steps performed on blanks or leaves of wrapping material, and a plurality of fixing steps performed on predetermined areas of the blanks or leaves, characterized in that the fixing steps comprise sealing operations whereby pairs of predetermined areas which are in mutual contact are sealed to each other, the predetermined areas each comprising a strip furnished with at least one layer of electrically conductive material.

2. A method as in claim 1, wherein each sealing operation comprises a step of passing a predetermined area through an electromagnetic field.

3. A method as in claim 1, wherein each sealing operation comprises a step of including a predetermined area in an electric circuit.

4. A container made using the method as in claim 1, wherein the strips furnished with at least one layer of electrically conductive material are designed to enable the predetermined areas to be joined to each other by fusing together.

5. A container as in claim 4, wherein the strips consist of a metallic layer.

6. A container as in claim 4, wherein the strip comprises an adhesive layer whereby the strip is applied to the wrapping material.

7. A container as in claim 4, wherein the metallic layer consists of a paper material containing metallic particles.
